(19) United States
(12) Patent Application Publication
(10) Pub. No.: US 2010/0182151 A1
(43) Pub. Date: Jul. 22, 2010

(54) Life Saving and Warning System for a Swimming Pool

(76) Inventor: Ping-Hsun Yang, Sihu Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/356,785

(22) Filed: Jan. 21, 2009

(51) Int. Cl. G08B 23/00

(52) U.S. Cl. 340/573.1

(57) ABSTRACT

A life saving and warning system for a swimming pool includes an electromagnetic wave emitting device, at least one electromagnetic wave receiving device, and a main processor. The main processor includes a counting device, a time preset device, and a warning device. Thus, when the user stays in the water during a longer period of time exceeding the predetermined time interval of the time preset device 31, the warning device 32 of the main processor 30 sends a warning signal to a life saver to notify the life saver that the user is drowning so that the life saver can get to the user to save the user's life so as to protect the user's safety when swimming in the swimming pool.

### BACKGROUND OF THE INVENTION

1. Field of the Invention

The present invention relates to a life saving and warning system and, more particularly, to a life saving and warning system for a swimming pool.

2. Description of the Related Art

A conventional swimming pool provides a larger space for use with players or swimmers to achieve playing and exercising functions to the users. However, the swimming pool does not have a warning device to provide a warning function to a life saver when the user encounters an emergency condition, for example, when the user is drowning, thereby greatly causing danger to the user when swimming in the swimming pool.

### BRIEF SUMMARY OF THE INVENTION

In accordance with the present invention, there is provided a life saving and warning system for a swimming pool, comprising an electromagnetic wave emitting device, at least one electromagnetic wave receiving device connected to the electromagnetic wave emitting device to receive an electromagnetic signal from the electromagnetic wave emitting device, and a main processor connected to the electromagnetic wave receiving device to read and process the electromagnetic signal of the electromagnetic wave receiving device.

The electromagnetic signal from the electromagnetic wave emitting device to the electromagnetic wave receiving device is interrupted during an interrupted time interval. The main processor includes a counting device to count the interrupted time interval of the electromagnetic signal from the electromagnetic wave emitting device to the electromagnetic wave receiving device, a time preset device to preset a predetermined time interval, and a warning device to send a warning signal when the interrupted time interval detected by the counting device is greater than the predetermined time interval of the time preset device.

The primary objective of the present invention is to provide a life saving and warning system for a swimming pool, wherein when the electromagnetic wave emitting device together with the user's head is immersed into the water level, the electromagnetic signal from the electromagnetic wave emitting device to the electromagnetic wave receiving device is interrupted during the interrupted time interval which is detected by the counting device of the main processor, so that when the interrupted time interval detected by the counting device is greater than the predetermined time interval of the time preset device, the warning device of the main processor sends a warning signal to a life saver to save the user's life so as to protect the user's safety when swimming in the swimming pool.

Another objective of the present invention is to provide a life saving and warning system for a swimming pool, wherein the pulse counter of the electromagnetic wave emitting device can count the user's pulse and send a pulse signal to the electromagnetic wave receiving device, so that the warning device of the main processor can send a warning signal to the life saver when the user's pulse stops.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a block diagram of a life saving and warning system for a swimming pool in accordance with the preferred embodiment of the present invention.

### DETAILED DESCRIPTION OF THE INVENTION

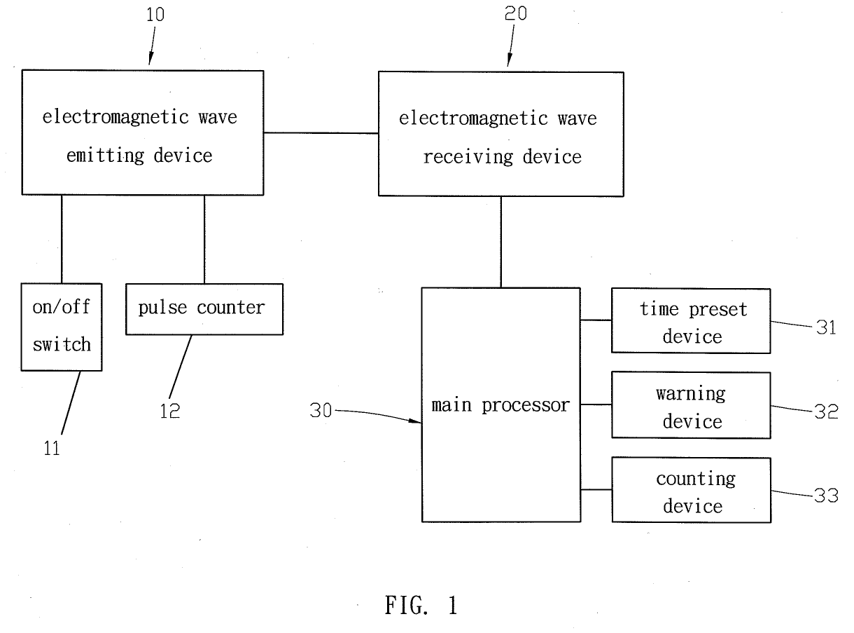

Referring to FIG. 1, a life saving and warning system for a swimming pool in accordance with the preferred embodiment of the present invention comprises an electromagnetic wave emitting device 10, at least one electromagnetic wave receiving device 20 connected to the electromagnetic wave emitting device 10 to receive an electromagnetic signal from the electromagnetic wave emitting device 10, and a main processor 30 connected to the electromagnetic wave receiving device 20 to read and process the electromagnetic signal of the electromagnetic wave receiving device 20.

The electromagnetic wave emitting device 10 is mounted on a user's body. The user's body can project outwardly from the water level of the swimming pool and can be immersed into the water level of the swimming pool. Preferably, the electromagnetic wave emitting device 10 is mounted on the user's head. The electromagnetic wave emitting device 10 includes an on/off switch 11 to control operation of the electromagnetic wave emitting device 10. The electromagnetic wave emitting device 10 further includes a pulse counter 12 to count the user's pulse and to send a pulse signal to the electromagnetic wave receiving device 20.

The electromagnetic wave receiving device 20 is mounted on a peripheral position of a swimming pool. Thus, when the electromagnetic wave emitting device 10 together with the user's head is immersed into the water level, the electromagnetic signal from the electromagnetic wave emitting device 10 to the electromagnetic wave receiving device 20 is interrupted during an interrupted time interval, and the electromagnetic wave receiving device 20 cannot receive the electromagnetic signal from the electromagnetic wave emitting device 10 during the interrupted time interval.

The main processor 30 is mounted on the peripheral position of the swimming pool. The main processor 30 includes a counting device 33 to count the interrupted time interval of the electromagnetic signal from the electromagnetic wave emitting device 10 to the electromagnetic wave receiving device 20, a time preset device 31 to preset a predetermined time interval, and a warning device 32 to send a warning signal to a life saver when the interrupted time interval detected by the counting device 33 is greater than the predetermined time interval of the time preset device 31. The counting device 33 of the main processor 30 identifies the user's position according to a power value of the electromagnetic signal from the electromagnetic wave emitting device 10 to the electromagnetic wave receiving device 20.

In practice, when the electromagnetic wave emitting device 10 together with the user's head projects outwardly from the water level of the swimming pool, the electromagnetic signal is transmitted successively from the electromagnetic wave emitting device 10 to the electromagnetic wave receiving device 20 without interruption, and when the electromagnetic wave emitting device 10 together with the user's head is immersed into the water level, the electromagnetic signal attenuates quickly in the water level and cannot penetrate the water level, so that the electromagnetic signal from the electromagnetic wave emitting device 10 to the electromagnetic wave receiving device 20 is interrupted during the interrupted time interval, and the electromagnetic wave receiving device 20 cannot receive the electromagnetic signal from the electromagnetic wave emitting device 10 during the interrupted time interval which is detected by the counting device 33 of the main processor 30. In such a manner, when the interrupted time interval detected by the counting device 33 is greater than the predetermined time interval of the time preset device 31, the warning device 32 of the main processor 30 sends a warning signal to a life saver to notify the life saver that the user is drowning. Thus, when the user stays in the water during a longer period of time exceeding the predetermined time interval of the time preset device 31, the warning device 32 of the main processor 30 sends a warning signal to the life saver to notify the life saver that the user is drowning so that the life saver can get to the user to save the user's life so as to protect the user's safety when swimming in the swimming pool.

Accordingly, when the electromagnetic wave emitting device 10 together with the user's head is immersed into the water level, the electromagnetic signal from the electromagnetic wave emitting device 10 to the electromagnetic wave receiving device 20 is interrupted during the interrupted time interval which is detected by the counting device 33 of the main processor 30, so that when the interrupted time interval detected by the counting device 33 is greater than the predetermined time interval of the time preset device 31, the warning device 32 of the main processor 30 sends a warning signal to a life saver to save the user's life so as to protect the user's safety when swimming in the swimming pool. In addition, the pulse counter 12 of the electromagnetic wave emitting device 10 can count the user's pulse and send a pulse signal to the electromagnetic wave receiving device 20, so that the warning device 32 of the main processor 30 can send a warning signal to the life saver when the user's pulse stops.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A life saving and warning system for a swimming pool, comprising:
an electromagnetic wave emitting device;
at least one electromagnetic wave receiving device connected to the electromagnetic wave emitting device to receive an electromagnetic signal from the electromagnetic wave emitting device;
a main processor connected to the electromagnetic wave receiving device to read and process the electromagnetic signal of the electromagnetic wave receiving device.

2. The life saving and warning system for a swimming pool of claim 1, wherein
the electromagnetic wave emitting device is mounted on a user's body;
the electromagnetic wave receiving device is mounted on a peripheral position of a swimming pool;
the main processor is mounted on the peripheral position of the swimming pool.

3. The life saving and warning system for a swimming pool of claim 1, wherein the electromagnetic wave emitting device is mounted on the user's head.

4. The life saving and warning system for a swimming pool of claim 1, wherein
the electromagnetic signal from the electromagnetic wave emitting device to the electromagnetic wave receiving device is interrupted during an interrupted time interval;
the main processor includes:
a counting device to count the interrupted time interval of the electromagnetic signal from the electromagnetic wave emitting device to the electromagnetic wave receiving device;
a time preset device to preset a predetermined time interval;
a warning device to send a warning signal when the interrupted time interval detected by the counting device is greater than the predetermined time interval of the time preset device.

5. The life saving and warning system for a swimming pool of claim 4, wherein the electromagnetic wave receiving device cannot receive the electromagnetic signal from the electromagnetic wave emitting device during the interrupted time interval.

6. The life saving and warning system for a swimming pool of claim 1, wherein the electromagnetic wave emitting device includes an on/off switch to control operation of the electromagnetic wave emitting device.

7. The life saving and warning system for a swimming pool of claim 1, wherein the electromagnetic wave emitting device includes a pulse counter to count a user's pulse and to send a pulse signal to the electromagnetic wave receiving device.

8. The life saving and warning system for a swimming pool of claim 4, wherein when the electromagnetic wave emitting device is immersed into a water level, the electromagnetic signal from the electromagnetic wave emitting device to the electromagnetic wave receiving device is interrupted during the interrupted time interval, and the electromagnetic wave receiving device cannot receive the electromagnetic signal from the electromagnetic wave emitting device during the interrupted time interval which is detected by the counting device of the main processor.
